(19) United States
(12) Patent Application Publication
(10) Pub. No.: US 2023/0407872 A1
(43) Pub. Date: Dec. 21, 2023

(54) SYSTEM FOR OPERATING OIL PUMP FOR MOBILITY VEHICLE

(71) Applicants: Hyundai Motor Company, Seoul (KR); Kia Corporation, Seoul (KR)

(72) Inventors: Jin Young HWANG, Suwon-Si (KR); Joong Kyu YOO, Incheon (KR); Won Seok OH, Incheon (KR); Seong Min SON, Pohang-Si (KR); Ki Bum KIM, Seoul (KR); Se Hwan JO, Bucheon-Si (KR); Bong Uk BAE, Daegu (KR)

(73) Assignees: Hyundai Motor Company, Seoul (KR); Kia Corporation, Seoul (KR)

(21) Appl. No.: 17/729,501

(22) Filed: Apr. 26, 2022

(30) Foreign Application Priority Data
Nov. 9, 2021 (KR) 10-2021-0152946

(51) Int. Cl. F04D 15/00; F04D 13/02; F16D 48/06

(52) U.S. Cl. CPC F04D 15/00; F04D 13/021; F16D 48/06; F16D 2500/1107; F16D 2500/10493

(57) ABSTRACT

An oil pump is connected to an electric motor and receives driving power, and the oil pump operates normally in a forward direction at normal times regardless of whether the electric motor operates in the forward or reverse direction thereof. Therefore, according to A system for operating an oil pump for a vehicle, the oil pump, which operates in conjunction with the electric motor, is applied, which reduces costs in comparison with an electric oil pump. Furthermore, regardless of whether the electric motor operates in the forward or reverse direction, the oil pump operates normally, which normally circulates oil and stabilizes components of an oil system.

### CROSS REFERENCE TO RELATED APPLICATION

The present application claims priority to Korean Patent Application No. 10-2021-0152946, filed Nov. 9, 2021, the entire contents of which is incorporated herein for all purposes by this reference.

### BACKGROUND OF THE PRESENT DISCLOSURE

### Field of the Present Disclosure

The present disclosure relates to a system for operating an oil pump for a mobility vehicle, which rotates an oil pump in a forward direction even though a drive system operates in a reverse direction in a structure in which the drive system and the oil pump are connected.

### Description of Related Art

Recently, electric vehicles have been considered as necessary means for implementing environmentally friendly technologies and solving social issues such as energy depletion. The electric vehicle operates using a motor that outputs power by being supplied with electricity from a battery. Because the electric vehicle emits no carbon dioxide, generates very low noise, and utilizes the motor with energy efficiency higher than energy efficiency of an engine, the electric vehicle is in the limelight as an environmentally friendly vehicle.

A key technology for implementing the electric vehicle is related to a battery module. Recently, studies have been actively conducted on a reduction in weight of a battery, a reduction in size of the battery, and a reduction in time taken to charge the battery. The battery module needs to be used in an optimal temperature environment to maintain an optimal performance and a long lifespan.

Meanwhile, recently, the motorization of powertrains has been rapidly performed to meet the strict regulations on emission and the requirement of high fuel economy. Therefore, the applications of transmissions and speed reducers for electric vehicles are increased. To the present end, an oil pump is frequently mounted to lubricate a gear train, a bearing, and a motor.

In the instant case, an electric oil pump configured for actively controlling a supply flow rate is most efficiently applied as the oil pump. However, a motor, a controller, and separate wiring need to be provided, which causes a problem with an increase in costs and weight.

Therefore, the oil pump is sometimes mounted to be operated directly. However, in the case of the electric vehicle, the oil pump cannot operate normally when rotational power made by a forward or reverse rotation of a motor is applied to the oil pump at the time of operating the oil pump by use of driving power of the motor.

That is, there is no problem with an engine at the time of operating the oil pump by use of rotational power of the engine because the engine operates in a forward direction at normal times. However, because the motor for an electric vehicle may rotate in a forward or reverse direction depending on a traveling direction of the vehicle, there is a problem in that the oil pump cannot operate normally when the motor rotates in the reverse direction to move the electric vehicle rearward thereof. Furthermore, there is a limitation in that the oil pump cannot operate normally even though a transmission is applied because the transmission also operates only in the forward direction thereof.

The information included in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a system for operating an oil pump configured for a mobility vehicle, which allows the oil pump, which is connected to an electric motor and receives driving power, to operate in a forward direction at normal times and thus operate normally regardless of whether the electric motor operates in a forward or reverse direction thereof.

Various aspects of the present disclosure are directed to providing a system for operating an oil pump configured for a mobility vehicle, the system including: a driveshaft connected to a drive unit and configured to receive rotational power from the drive unit; an output shaft engaged to the driveshaft and configured to output the rotational power; a pump shaft connected to an oil pump; a first power transmission unit coupled to the driveshaft and the pump shaft and including a first one-way clutch; and a second power transmission unit coupled to the output shaft and the pump shaft and including a second one-way clutch, in which the rotational power of any one of the driveshaft and the output shaft is transmitted as rotational power in a predetermined direction to the pump shaft as the first one-way clutch and the second one-way clutch are engaged or disengaged regardless of whether an operation direction of the drive unit is changed.

The driveshaft and the output shaft may be fastened to each other by gears, and the output shaft may rotate in a direction opposite to a rotation direction of the driveshaft when the driveshaft is rotated by the drive unit.

The output shaft may include: a first output shaft coupled to the driveshaft by gears and configured to rotate in a reverse direction when the driveshaft rotates; and a second output shaft coupled to the first output shaft by gears and configured to rotate in a reverse direction to the first output shaft and rotate in a same direction as the driveshaft.

The first power transmission unit may include a first connection portion and the first one-way clutch, the first connection portion may be provided on the driveshaft, the first one-way clutch may be provided on the pump shaft, and the first connection portion and the first one-way clutch may be connected by a chain or a belt.

The first power transmission unit may include a first connection portion and the first one-way clutch, the first connection portion may be provided on the pump shaft, the first one-way clutch may be provided on the driveshaft, and the first connection portion and the first one-way clutch may be connected by a chain or a belt.

The second power transmission unit may include a second connection portion and the second one-way clutch, the second connection portion may be provided on the output shaft, the second one-way clutch may be provided on the pump shaft, and the second connection portion and the second one-way clutch may be connected by a chain or a belt.

The second power transmission unit may include a second connection portion and the second one-way clutch, the second connection portion may be provided on the pump shaft, the second one-way clutch may be provided on the output shaft, and the second connection portion and the second one-way clutch may be connected by a chain or a belt.

The system may further include a control unit configured to control the drive unit, the first one-way clutch, and the second one-way clutch, and the control unit may engage the first one-way clutch and disengage the second one-way clutch when the drive unit operates in a forward direction thereof.

The control unit may disengage the first one-way clutch and engage the second one-way clutch when the drive unit operates in a reverse direction thereof.

According to the system for operating an oil pump configured for a mobility vehicle structured as described above, the oil pump is connected to the electric motor and receives the driving power, and the oil pump operates normally in the forward direction at normal times regardless of whether the electric motor operates in the forward or reverse direction thereof.

Therefore, according to an exemplary embodiment of the present disclosure, the oil pump, which operates in conjunction with the electric motor, is applied, which reduces costs in comparison with an electric oil pump. Furthermore, regardless of whether the electric motor operates in the forward or reverse direction, the oil pump operates normally, which normally circulates the oil and stabilizes components of an oil system.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating a system for operating an oil pump configured for a mobility vehicle according to an exemplary embodiment of the present disclosure.

FIG. 2 is a view exemplarily illustrating a first power transmission unit and a second power transmission unit according to various exemplary embodiments of the present disclosure.

FIG. 3 is a view exemplarily illustrating a first power transmission unit and a second power transmission unit according to various exemplary embodiments of the present disclosure.

FIG. 4 is a view for explaining a state in which a drive unit operates in a forward direction thereof.

FIG. 5 is a view for explaining a state in which the drive unit operates in a reverse direction thereof.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, a system for operating an oil pump configured for a mobility vehicle according to various exemplary embodiments of the present disclosure will be described with reference to the accompanying drawings.

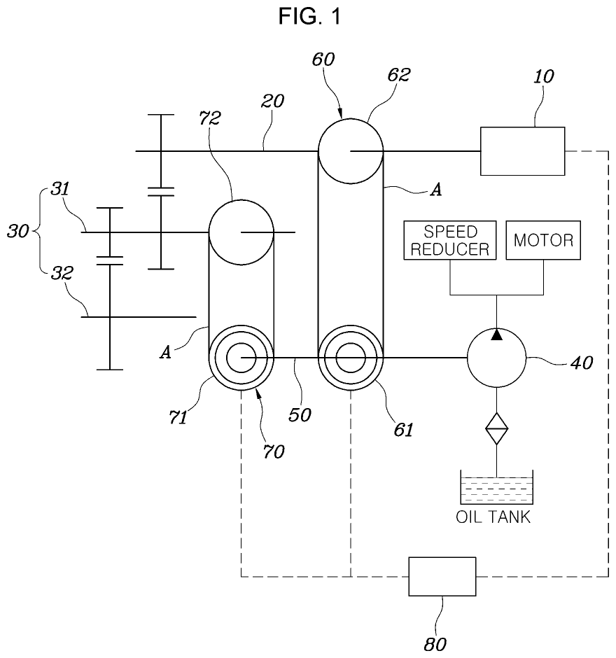

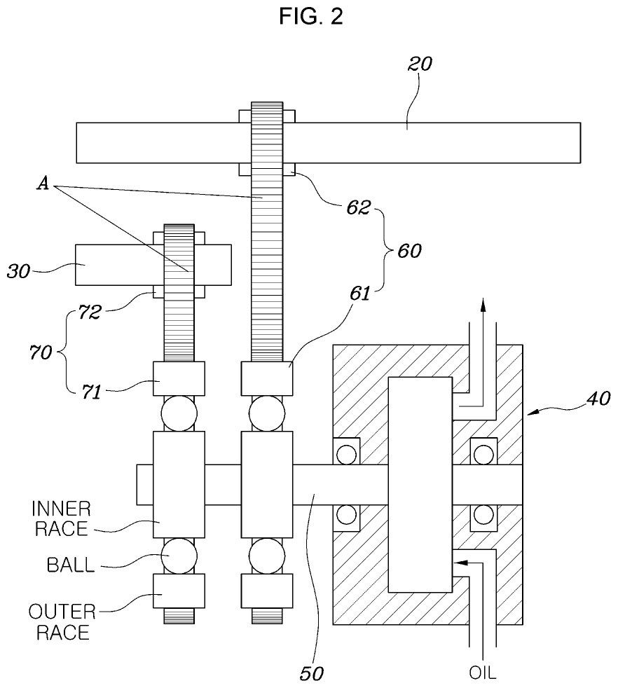

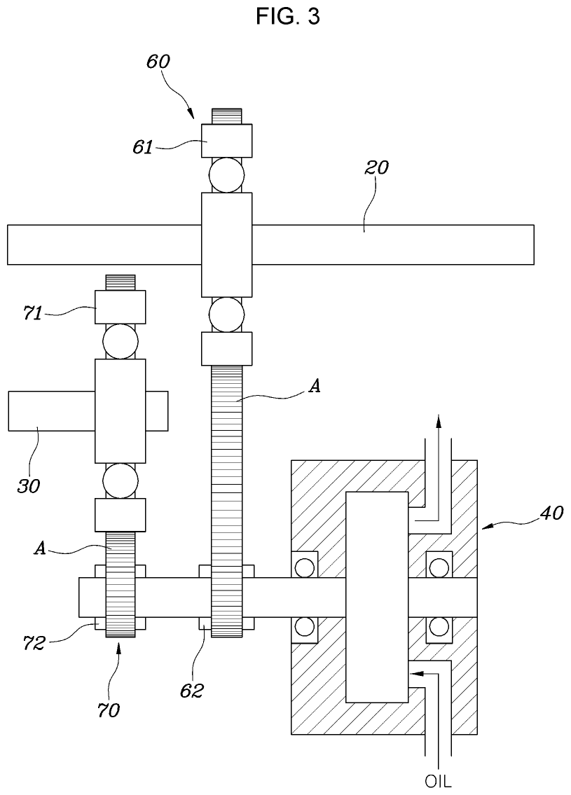

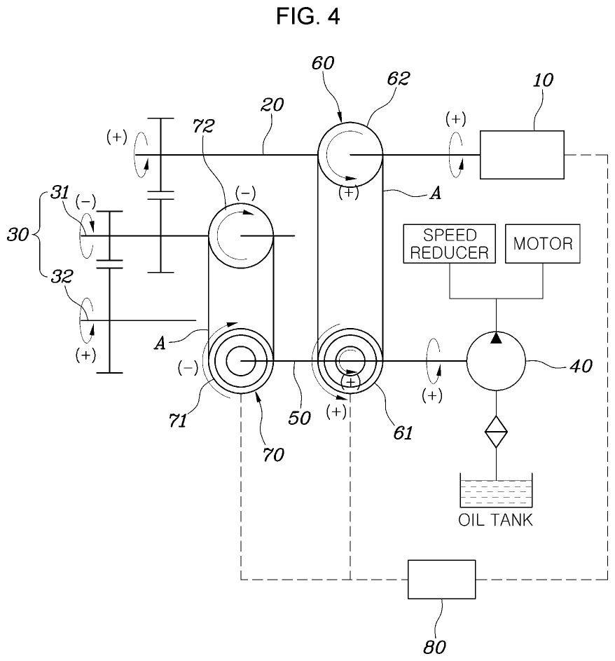

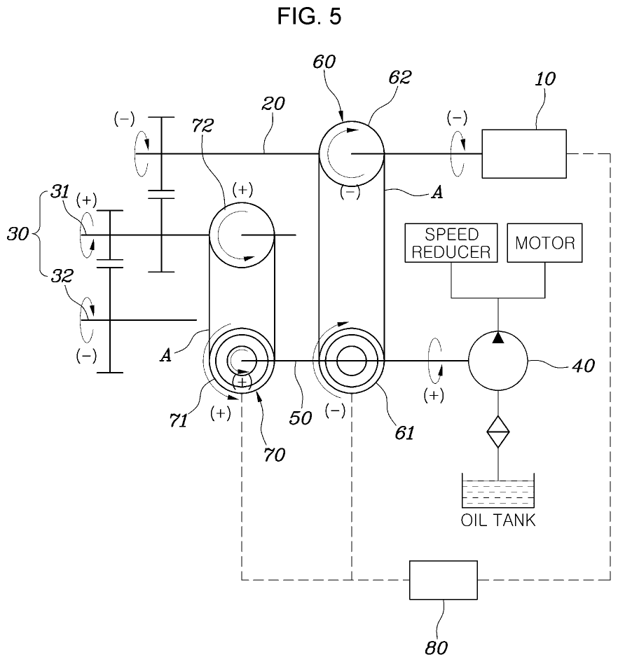

FIG. 1 is a view exemplarily illustrating a system for operating an oil pump configured for a mobility vehicle according to an exemplary embodiment of the present disclosure, FIG. 2 is a view exemplarily illustrating a first power transmission unit and a second power transmission unit according to various exemplary embodiments of the present disclosure, FIG. 3 is a view exemplarily illustrating a first power transmission unit and a second power transmission unit according to various exemplary embodiments of the present disclosure, FIG. 4 is a view for explaining a state in which a drive unit operates in a forward direction, and FIG. 5 is a view for explaining a state in which the drive unit operates in a reverse direction thereof.

As illustrated in FIG. 1, a system for operating an oil pump configured for a mobility vehicle according to various exemplary embodiments of the present disclosure may include a driveshaft 20 connected to a drive unit 10 and configured to receive rotational power; an output shaft 30 coupled to the driveshaft 20 and configured to output the rotational power; a pump shaft 50 connected to an oil pump 40; a first power transmission unit 60 connected to the driveshaft 20 and the pump shaft 50 and including a first one-way clutch 61; and a second power transmission unit 70 connected to the output shaft 30 and the pump shaft 50 and including a second one-way clutch 71.

In the instant case, the drive unit 10 may be configured as an electric motor. A rotation direction of the driveshaft 20 is determined depending on an operation direction of the electric motor. For example, under a condition in which the mobility vehicle travels forward, the drive unit 10 rotates in a forward direction, and the driveshaft 20 rotates in the forward direction thereof. Under a condition in which the mobility vehicle travels rearward thereof, the drive unit 10 rotates in a reverse direction, and the driveshaft 20 rotates in the reverse direction thereof.

The drive unit 10 is connected to one side of the driveshaft 20, the output shaft 30 is connected to the other side of the driveshaft 20, and the rotational power, which is generated when the drive unit 10 operates, is transmitted to the output shaft 30 through the driveshaft 20 so that a drive wheel connected to the output shaft 30 rolls, and the mobility vehicle travels.

Furthermore, the pump shaft 50 is connected to the driveshaft 20 by the first power transmission unit 60. In the instant case, the oil pump 40 is connected to the pump shaft 50, and the oil pump 40 operates when the pump shaft 50 rotates by receiving the rotational power of the driveshaft 20. The oil pump 40 is connected to an oil tank, a speed reducer, and a motor and circulates oil to lubricate respective components and control temperatures.

The pump shaft 50 is also connected to the output shaft 30 by the second power transmission unit 70. Therefore, the oil pump 40 may operate even when the pump shaft 50 receives the rotational power through the output shaft 30. However, because the driveshaft 20 and the output shaft 30 rotate in opposite directions because of a connection structure therebetween, the pump shaft 50 is configured to receive the rotational power through any one of the driveshaft 20 and the output shaft 30. To the present end, the pump shaft 50 is connected to the driveshaft 20 by the first one-way clutch 61 provided in the first power transmission unit 60, and the pump shaft 50 is connected to the output shaft 30 by the second one-way clutch 71 provided in the second power transmission unit 70. Therefore, the pump shaft 50 may receive the rotational power selectively from the driveshaft 20 or the output shaft 30 as the first one-way clutch 61 and the second one-way clutch 71 are engaged or disengaged.

In the instant case, a detailed operational structure of each of the first and second one-way clutches 61 and 71 is identical to that of a typical one-way clutch, and a description of a specific configuration thereof will be omitted.

As described above, according to an exemplary embodiment of the present disclosure, the rotational power of any one of the driveshaft 20 and the output shaft 30 is transmitted to the pump shaft 50 as the first one-way clutch 61 and the second one-way clutch 71 are engaged or disengaged so that the pump shaft 50 may rotate only in one direction regardless of whether the drive unit 10, which forms the electric motor, operates in the forward or reverse direction thereof.

The present disclosure will be specifically described. As illustrated in FIG. 1, the driveshaft 20 and the output shaft 30 are fastened to each other by gears so that when the driveshaft 20 is rotated by the drive unit 10, the output shaft 30 rotates in the direction opposite to the rotation direction of the driveshaft 20.

Since the driveshaft 20 and the output shaft 30 are fastened to each other as described above, the output shaft 30 may rotate together with the driveshaft 20 when the driveshaft 20 rotates. Since the driveshaft 20 and the output shaft 30 are fastened by the gears, the rotational torque may be determined by adjusting a gear ratio. It is possible to determine rotational torque according to the specifications of the mobility vehicle by adjusting the rotational torque of the rotational power, which is generated by the operation of the drive motor, by adjusting the gear ratio of the connection structure between the driveshaft 20 and the output shaft 30.

Meanwhile, the output shaft 30 may include: a first output shaft 31 fastened to the driveshaft 20 by gears and configured to rotate in the reverse direction when the driveshaft 20 rotates; and a second output shaft 32 fastened to the first output shaft 31 by gears and configured to rotate in the reverse direction to the first output shaft 31 and thus rotate in the same direction as the driveshaft 20.

As described above, the output shaft 30 includes the first output shaft 31 and the second output shaft 32, and the driveshaft 20, the first output shaft 31, and the second output shaft 32 are fastened to one another by the gears, which makes it possible to adjust the rotational torque by adjusting the respective gear ratios. Furthermore, the output direction in which the power is finally outputted is identical to the initial rotation direction of the driveshaft 20, which makes it easy to design the operation of the mobility vehicle. That is, when the drive unit 10 operates in the forward direction and the driveshaft 20 rotates in the forward direction, the first output shaft 31 rotates in the reverse direction, i.e., the opposite direction to the driveshaft 20, and the second output shaft 32 rotates in the forward direction, i.e., the opposite direction to the first output shaft 31 so that the rotation direction of the second output shaft 32 is finally coincident with the direction of the rotational power of the finally drive unit 10.

Furthermore, the driveshaft 20 may be connected to the pump shaft 50 by the first power transmission unit 60, the first output shaft 31 may be connected to the pump shaft 50 by the second power transmission unit 70, and the third output shaft 30, through which the rotational power is finally outputted, may be connected to the drive wheel. Therefore, the configuration including the driveshaft 20, the first output shaft 31, and the second output shaft 32 solves the problem caused when the distribution of the rotational power is concentrated on one side thereof.

Meanwhile, as illustrated in FIG. 2, the first power transmission unit 60 includes a first connection portion 62 and the first one-way clutch 61. The first connection portion 62 may be provided on the driveshaft 20, the first one-way clutch 61 may be provided on the pump shaft 50, and the first connection portion 62 and the first one-way clutch 61 may be connected to each other by a chain or belt A.

Therefore, when the driveshaft 20 rotates as the drive unit 10 operates, the rotational power of the driveshaft 20 may be transmitted to the pump shaft 50 through the first connection portion 62, the chain or belt A, and the first one-way clutch 61. In the instant case, the first one-way clutch 61 is selectively engaged or disengaged, and the rotational power of the driveshaft 20 is selectively applied to the pump shaft 50 depending on whether the first one-way clutch 61 is engaged.

Furthermore, the second power transmission unit 70 includes a second connection portion 72 and the second one-way clutch 71. The second connection portion 72 may be provided on the output shaft 30, the second one-way clutch 71 may be provided on the pump shaft 50, and the second connection portion 72 and the second one-way clutch 71 may be connected to each other by a chain or belt A.

Therefore, when the drive unit 10 operates, the output shaft 30 connected to the driveshaft 20 rotates, and the rotational power transmitted through the output shaft 30 may be transmitted to the pump shaft 50 through the second connection portion 72, the chain or belt A, and the second one-way clutch 71. In the instant case, the second one-way clutch 71 is selectively engaged or disengaged, and the rotational power of the output shaft 30 is selectively applied to the pump shaft 50 depending on whether the second one-way clutch 71 is engaged.

Because the first one-way clutch 61 and the second one-way clutch 71 are provided on the pump shaft 50 as described above, it is possible to simplify the structures of the driveshaft 20 and the output shaft 30 and determine whether to transmit the rotational power to the pump shaft 50.

Meanwhile, as illustrated in FIG. 3, the first power transmission unit 60 includes the first connection portion 62 and the first one-way clutch 61. The first connection portion 62 may be provided on the pump shaft 50, the first one-way clutch 61 may be provided on the driveshaft 20, and the first connection portion 62 and the first one-way clutch 61 may be connected to each other by the chain or belt A.

Therefore, when the driveshaft 20 rotates as the drive unit 10 operates, the rotational power of the driveshaft 20 may be transmitted to the pump shaft 50 through the first one-way clutch 61, the chain or belt A, and the first connection portion 62. In the instant case, the first one-way clutch 61 is selectively engaged or disengaged, and the rotational power of the driveshaft 20 is selectively applied to the pump shaft 50 depending on whether the first one-way clutch 61 is engaged.

Meanwhile, the second power transmission unit 70 includes the second connection portion 72 and the second one-way clutch 71. The second connection portion 72 may be provided on the pump shaft 50, the second one-way clutch 71 may be provided on the output shaft 30, and the second connection portion 72 and the second one-way clutch 71 may be connected to each other by the chain or belt A.

Therefore, when the drive unit 10 operates, the output shaft 30 connected to the driveshaft 20 rotates, and the rotational power transmitted through the output shaft 30 may be transmitted to the pump shaft 50 through the second one-way clutch 71, the chain or belt A, and the second connection portion 72. In the instant case, the second one-way clutch 71 is selectively engaged or disengaged, and the rotational power of the output shaft 30 is selectively applied to the pump shaft 50 depending on whether the second one-way clutch 71 is engaged.

Because the first one-way clutch 61 is provided on the driveshaft 20 and the second one-way clutch 71 is provided on the output shaft 30 as described above, it is possible to simplify the structure of the pump shaft 50 connected to the oil pump 40 and selectively determine whether to transmit the rotational power to the pump shaft 50.

Meanwhile, the system further includes a control unit 80 configured to control the drive unit 10, the first one-way clutch 61, and the second one-way clutch 71. The control unit 80 may collect information on a traveling state of the mobility vehicle and control the drive unit 10, the first one-way clutch 61, and the second one-way clutch 71.

For example, the control unit 80 engages the first one-way clutch 61 and disengages the second one-way clutch 71 when the drive unit 10 operates in the forward direction thereof.

As illustrated in FIG. 4, when the drive unit 10 operates in the forward direction to move the mobility vehicle forward, the control unit 80 engages the first one-way clutch 61 to transmit the rotational power between the driveshaft 20 and the pump shaft 50 and disengages the second one-way clutch 71 to cut off the transmission of the rotational power between the output shaft 30 and the pump shaft 50.

Therefore, when the forward rotational power is generated by the drive unit 10, the driveshaft 20 rotates in the forward direction, and the first one-way clutch 61 is engaged so that the forward rotational power of the driveshaft 20 is transmitted to the pump shaft 50 through the first power transmission unit 60. That is, an external race and an internal race of the first one-way clutch 61 rotate together as the first one-way clutch 61 is engaged, and the driveshaft 20 and the pump shaft 50 are connected to transmit the rotational power through the chain or belt.

In the instant case, the output shaft 30 connected to the driveshaft 20 rotates in the reverse direction, and the second one-way clutch 71 is disengaged so that the reverse rotational power of the output shaft 30 is not transmitted to the pump shaft 50. Therefore, the pump shaft 50 rotates in the forward direction so that the oil pump 40 may operate normally.

Meanwhile, the control unit 80 disengages the first one-way clutch 61 and engages the second one-way clutch 71 when the drive unit 10 operates in the reverse direction thereof.

As illustrated in FIG. 5, when the drive unit 10 operates in the reverse direction to move the mobility vehicle rearward thereof, the control unit 80 disengages the first one-way clutch 61 to cut off the transmission of the rotational power between the driveshaft 20 and the pump shaft 50 and engages the second one-way clutch 71 to transmit the rotational power between the output shaft 30 and the pump shaft 50.

Therefore, when the reverse rotational power is generated by the drive unit 10, the driveshaft 20 rotates in the reverse direction, and the first one-way clutch 61 is disengaged so that the reverse rotational power of the driveshaft 20 is not transmitted to the pump shaft 50. In the instant case, the output shaft 30 connected to the driveshaft 20 rotates in the forward direction as the rotational power of the driveshaft 20 is reversed, and the forward rotational power of the output shaft 30 is transmitted to the pump shaft 50 as the second one-way clutch 71 is engaged. Therefore, the pump shaft 50 rotates in the forward direction so that the oil pump 40 may operate normally.

According to the system for operating the oil pump 40 of the mobility vehicle structured as described above, the oil pump 40 is connected to the electric motor and receives the driving power, and the oil pump 40 operates normally in the forward direction at normal times regardless of whether the electric motor operates in the forward or reverse direction thereof.

Therefore, according to an exemplary embodiment of the present disclosure, the oil pump 40, which operates in conjunction with the electric motor, is applied, which reduces costs in comparison with an electric oil pump. Furthermore, regardless of whether the electric motor operates in the forward or reverse direction, the oil pump 40 operates normally, which normally circulates the oil and stabilizes components of an oil system.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the control device may be implemented in a form of hardware or software, or may be implemented in a combination of hardware and software.

Furthermore, the terms such as “unit”, “module”, etc. Included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A system for operating an oil pump for a vehicle, the system comprising:
a driveshaft connected to a drive unit and configured to receive rotational power from the drive unit;
an output shaft engaged to the driveshaft and configured to output the rotational power;
a pump shaft connected to an oil pump;
a first power transmission unit coupled to the driveshaft and the pump shaft and including a first one-way clutch; and
a second power transmission unit coupled to the output shaft and the pump shaft and including a second one-way clutch,
wherein the rotational power of one of the driveshaft and the output shaft is transmitted as rotational power in a predetermined direction to the pump shaft as the first one-way clutch and the second one-way clutch are engaged or disengaged regardless of whether an operation direction of the drive unit is changed.

2. The system of claim 1, wherein the driveshaft and the output shaft are fastened to each other by gears, and the output shaft rotates in a direction opposite to a rotation direction of the driveshaft when the driveshaft is rotated by the drive unit.

3. The system of claim 1, wherein the output shaft includes:
a first output shaft coupled to the driveshaft by gears and configured to rotate in a reverse direction when the driveshaft rotates; and
a second output shaft coupled to the first output shaft by gears and configured to rotate in a reverse direction to the first output shaft and rotate in a same direction as the driveshaft.

4. The system of claim 1,
wherein the first power transmission unit includes a first connection portion and the first one-way clutch, and
wherein the first connection portion is provided on the driveshaft, the first one-way clutch is provided on the pump shaft, and the first connection portion and the first one-way clutch are connected by a chain or a belt.

5. The system of claim 1,
wherein the first power transmission unit includes a first connection portion and the first one-way clutch, and
wherein the first connection portion is provided on the pump shaft, the first one-way clutch is provided on the driveshaft, and the first connection portion and the first one-way clutch are connected by a chain or a belt.

6. The system of claim 1,
wherein the second power transmission unit includes a second connection portion and the second one-way clutch, and
wherein the second connection portion is provided on the output shaft, the second one-way clutch is provided on the pump shaft, and the second connection portion and the second one-way clutch are connected by a chain or a belt.

7. The system of claim 1,
wherein the second power transmission unit includes a second connection portion and the second one-way clutch, and
wherein the second connection portion is provided on the pump shaft, the second one-way clutch is provided on the output shaft, and the second connection portion and the second one-way clutch are connected by a chain or a belt.

8. The system of claim 1, further including:
a control unit configured to control the drive unit, the first one-way clutch, and the second one-way clutch,
wherein the control unit is configured to engage the first one-way clutch and to disengage the second one-way clutch when the drive unit operates in a forward direction thereof.

9. The system of claim 8, wherein the control unit is configured to disengage the first one-way clutch and to engage the second one-way clutch when the drive unit operates in a reverse direction thereof.
